(19) United States
(12) Patent Application Publication
(10) Pub. No.: US 2014/0160663 A1
(43) Pub. Date: Jun. 12, 2014

(54) SERIAL ADVANCED TECHNOLOGY ATTACHMENT DUAL IN-LINE MEMORY MODULE DEVICE AND MOTHERBOARD SUPPORTING THE SAME

(71) Applicants: HONG FU JIN PRECISION INDUSTRY (SHENZHEN) CO., LTD., Shenzhen (CN); HON HAI PRECISION INDUSTRY CO., LTD., New Taipei (TW)

(72) Inventor: WU ZHOU, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/726,619

(22) Filed: Dec. 26, 2012

(30) Foreign Application Priority Data
Dec. 6, 2012 (CN) 201210517851.4

(51) Int. Cl. G06F 13/38

(52) U.S. Cl. CPC G06F 13/382
USPC 361/679.32

(57) ABSTRACT

A motherboard assembly includes a motherboard and a serial advanced technology attachment dual in-line memory module (SATA DIMM) device. The motherboard includes an expansion slot, a first universal serial bus (USB) connector, a power connector, and a central processing unit (CPU). The expansion slot includes a correct-insertion protrusion, first power pins connected to the power connector, and first signal pins connected to the CPU. The SATA DIMM device includes a circuit board. A second USB connector, a signal converting chip, a power circuit, a control chip, and a number of storage chips are all arranged on the circuit board. A notch in the circuit board receives the correct-insertion protrusion. An edge connector is arranged on a bottom side of the circuit board and includes second power pins connected to the power circuit, and second signal pins connected to the control chip.

### BACKGROUND

1. Technical Field

The present disclosure relates to a serial advanced technology attachment dual in-line memory module (SATA DIMM) device and a motherboard supporting the SATA DIMM device.

2. Description of Related Art

Solid state drives (SSD) store data on chips instead of on magnetic or optical discs, to be used for additional storage capacity. One type of SSD has the form factor of a DIMM module and it is called a SATA DIMM device. The SATA DIMM device can be inserted into a memory slot of a motherboard, to receive voltages from the motherboard through the memory slot and receive hard disk drive (HDD) signals through SATA connectors arranged on the SATA DIMM device and connected to a SATA connector of the motherboard. However, the number of memory slots is limited, thus only a limited quantity of SATA DIMM devices can be received. Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawing, like reference numerals designate corresponding parts throughout the several views.

FIG. 1 is an exploded, perspective view of a serial advanced technology attachment dual in-line memory module (SATA DIMM) device and a motherboard supporting the SATA DIMM device in accordance with an embodiment of the present disclosure.

FIGS. 2 and 3 are assembled, perspective views of the SATA DIMM device and the motherboard of FIG. 1.

### DETAILED DESCRIPTION

The disclosure, including the drawings, is illustrated by way of example and not by way of limitation. References to “an” or “one” embodiment in this disclosure are not necessarily to the same embodiment, and such references mean “at least one.”

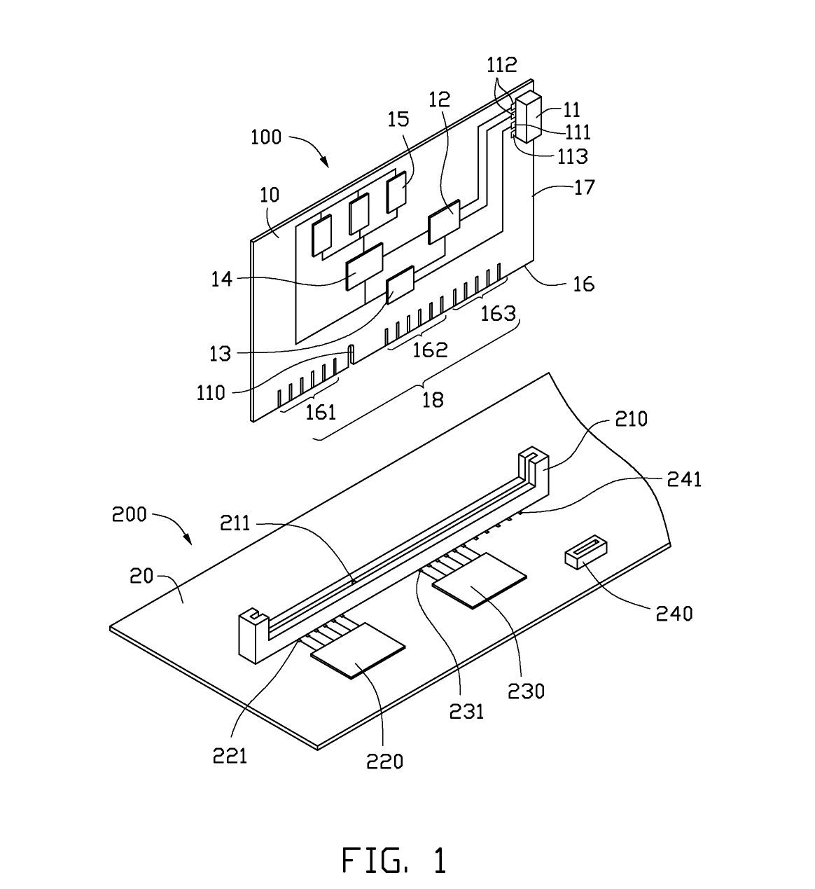

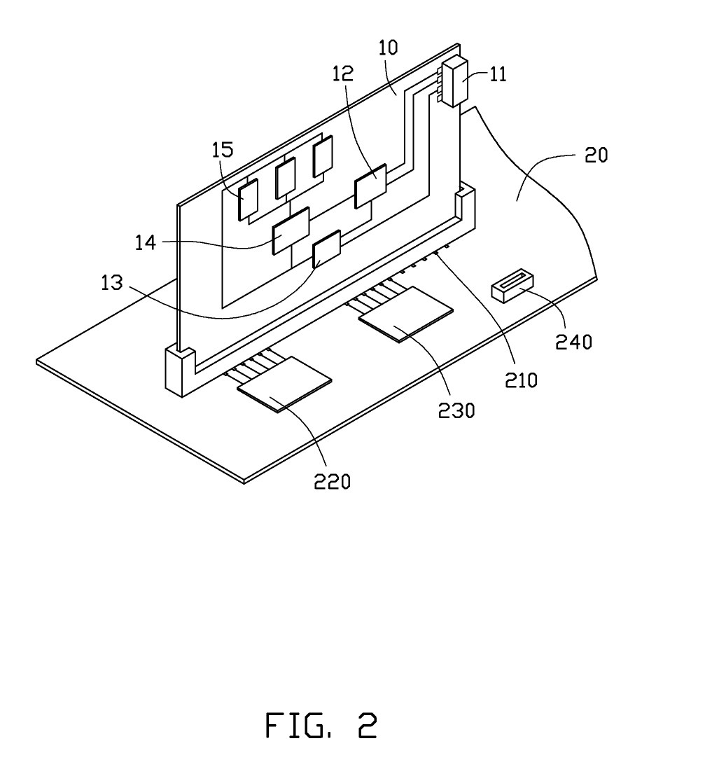

Referring to FIGS. 1 and 2, a serial advanced technology attachment dual in-line memory module (SATA DIMM) device 100 in accordance with an embodiment includes a substantially rectangular circuit board 10. A universal serial bus (USB) connector 11, a signal converting chip 12, a power circuit 13, a control chip 14, and a plurality of storage chips 15 are arranged on the circuit board 10. The USB connector 11 is arranged on a side 17 of the circuit board 10. In another embodiment, the USB connector 11 can be arranged on any side of the circuit board 10. An edge connector 18 is arranged on a bottom side 16 of the circuit board 10. The edge connector 18 includes a plurality of power pins 161, a plurality of signal pins 162, and a plurality of ground pins 163. A notch 110 is defined in the bottom side 16 of the circuit board 10 and located between the power pins 161 and the signal pins 162. The power pins 161 are connected to the power circuit 13. The signal pins 162 are connected to the control chip 14. The ground pins 163 are connected to a ground layer (not shown) of the circuit board 10. In one embodiment, the signal pins 162 transmit peripheral component interconnection (PCI) signals. The power circuit 13 is also connected to a power pin 111 of the USB connector 11. Two signal pins 112 of the USB connector 11 are connected to the signal converting chip 12. A ground pin 113 of the USB connector 11 is connected to a ground layer of the circuit board 10. The power circuit 13 is connected to the signal converting chip 12, the control chip 14, and the plurality of storage chips 15 for providing voltages to the signal converting chip 12, the control chip 14, and the storage chips 15. The control chip 14 is connected to the signal converting chip 12 and the storage chips 15. In other embodiments, the USB connector 11 may be an edge connector, which is arranged on the circuit board 10.

The motherboard 200 includes a circuit board 20. An expansion slot 210, a power connector 220, a central processing unit (CPU) 230, and a USB connector 240, are all arranged on the circuit board 20. In one embodiment, the expansion slot 210 is a PCI slot. The expansion slot 210 includes a correct-insertion protrusion 211 arranged in the expansion slot 210, a plurality of power pins 221, a plurality of signal pins 231, and a plurality of ground pins 241. The power pins 221 are connected to the power connector 220. The signal pins 231 are connected to the CPU 230. The ground pins 241 are connected to a ground layer (not shown) of the motherboard 200.

Referring to FIG. 2, in use, when the SATA DIMM module 100 is connected to the expansion slot 210 through the edge connector 18, the power pins 161 are connected to the power pins 221, the signal pins 162 are connected to the signal pins 231, and the ground pins 163 are connected to the ground pins 241. The protrusion 210 is engaged in the notch 110 to ensure insertion in the correct orientation. When the motherboard 200 receives power, the motherboard 200 outputs a voltage to the power circuit 13 through the power connector 220 and the power pins 221 and 161. The power circuit 13 converts the received voltage and provides it to the control chip 14 and the storage chips 15. At the same time, the CPU 230 outputs a bus signal, such as a PCI signal to the control chip 14 through the signal pins 231 and 162. The control chip 14 controls the storage chips 15 to store data according to the received PCI signal.

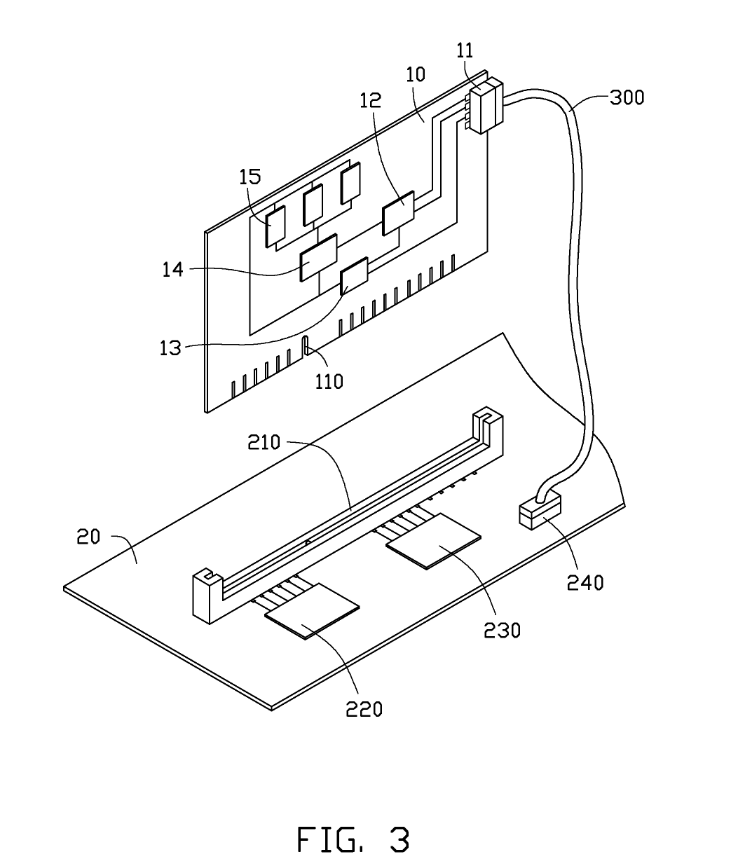

Referring to FIG. 3, when the SATA DIMM module 100 is connected to the motherboard 200 through the USB connectors 240 and 11 and a cable 300, and the motherboard 200 receives power, the motherboard 200 provides a voltage to the power circuit 13 through the USB connectors 240 and 11. The power circuit 13 converts the received voltage and provides it to the control chip 14, the storage chips 15, and the signal converting chip 12. At the same time, the motherboard 200 outputs a USB signal to the signal converting chip 12 through the USB connectors 240 and 11. The signal converting chip 12 converts the received USB signal to a PCI signal and outputs the PCI signal to the control chip 14. The control chip 14 controls the storage chips 15 to store data according to the received PCI signal.

The SATA DIMM device 100 receives the voltage and the PCI signal from the motherboard 200 through the expansion slot 210 and the edge connector 18, to make the control chip 14 control the storage of data by the storage chips 15. The SATA DIMM device 100 can also receive the voltage and the USB signal from the motherboard 200 through the USB connectors 240 and 11, to make the control chip 14 control the storage of data by the storage chips 15. Therefore, even though the number of memory slots of the motherboard 200 may be limited, a greater number of SATA DIMM devices 100 can communicate with the motherboard 200 through the USB connectors 240 and 11.

Even though numerous characteristics and advantages of the disclosure have been set forth in the foregoing description, together with details of the structure and function of the disclosure, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A serial advanced technology attachment dual in-line memory module (SATA DIMM) device, comprising:
a circuit board;
a power circuit arranged on the circuit board, to receive a voltage and convert the received voltage;
a signal converting chip arranged on the circuit board for converting a universal serial bus (USB) signal to a peripheral component interconnection (PCI) signal, and connected to the power circuit for receiving the converted voltage from the power circuit;
a USB connector arranged on the circuit board and comprising a first power pin connected to the power circuit, two first signal pins connected to the signal converting chip, and a first ground pin;
a plurality of storage chips arranged on the circuit board and connected to the power circuit, to receive the converted voltage from the power circuit;
a control chip arranged on the circuit board, connected to the signal converting chip, the plurality of storage chips, and the power circuit for receiving the converted voltage from the power circuit; and
an edge connector and a notch arranged on a bottom side of the circuit board, to be inserted into an expansion slot of a motherboard, wherein the edge connector comprises a plurality of second power pins connected to the power circuit, a plurality of second signal pins connected to the control chip, and a plurality of second ground pins;
wherein the power circuit converts a voltage received through the second power pins or the USB connector and outputs the converted voltage to the signal converting chip, the control chip, and the plurality of storage chips, the signal converting chip converts a first signal received through the USB connector to a second signal and outputs the second signal to the control chip, the control chip controls the plurality of storage chips to store data according to the received second signal from the signal converting chip or the second signal pins.

2. The SATA DIMM device of claim 1, wherein the edge connector is a PCI connector, the first signal is a USB signal, and the second signal is a PCI signal.

3. A motherboard for supporting a serial advanced technology attachment dual in-line memory module (SATA DIMM) device, the motherboard comprising:
a circuit board;
a USB connector mounted on the circuit board;
a power connector mounted on the circuit board;
a central processing unit (CPU) mounted on the circuit board; and
an expansion slot mounted on the circuit board, and comprising a protrusion arranged in the expansion slot, a plurality of power pins connected to the power connector, a plurality of ground pin, and a plurality of signal pins connected to the CPU.

4. The motherboard of claim 3, wherein the expansion slot is a peripheral component interconnection (PCI) slot.

5. A motherboard assembly, comprising:
a motherboard comprising a first circuit board, an expansion slot mounted on the first circuit board, a first universal serial bus (USB) connector mounted on the first circuit board, a power connector mounted on the first circuit board, and a central processing unit (CPU) mounted on the first circuit board, the expansion slot comprising a protrusion, a plurality of first power pins electrically connected to the power connector, a plurality of first ground pins, and a plurality of first signal pins connected to the CPU; and
a serial advanced technology attachment dual in-line memory module (SATA DIMM) device comprising a second circuit board, a second USB connector arranged on the second circuit board, a power circuit arranged on the second circuit board, a plurality of storage chips arranged on the second circuit board and connected to the power circuit, a signal converting chip arranged on the second circuit board and connected to the power circuit and the second USB connector, a control chip arranged on the second circuit board and connected to the power circuit, the signal converting chip, and the storage chips, and an edge connector and a notch set on a bottom side of the second circuit board to be detachably engaged in the expansion slot of the motherboard, the edge connector comprising a plurality of second power pins connected to the power circuit, a plurality of second ground pins, and a plurality of second signal pins connected to the control chip;
wherein in response to the edge connector of the SATA DIMM device being engaged in the expansion slot of the motherboard, the protrusion is engaged in the notch, the second signal pins of the SATA DIMM device are connected to the first signal pins of the expansion slot, the second power pins of the SATA DIMM device are connected to the first power pins of the expansion slot, the second ground pins of the SATA DIMM device are connected to the first ground pins of the expansion slot, the power circuit receives a voltage from the power connector through the first and second power pins, the control chip receives a peripheral component interconnection (PCI) signal from the CPU through the first and second signal pins; in response to the second USB connector of the SATA DIMM device is connected to the first USB connector of the motherboard, the power circuit receives a voltage and the signal converting chip receives a USB signal from the motherboard through the first and second USB connectors, the signal converting chip converts the USB signal to a PCI signal and outputs the PCI signal to the control chip.

6. The motherboard assembly of claim 5, wherein the edge connector is a PCI connector, the first signal is a USB signal, and the second signal is a PCI signal.

7. The motherboard assembly of claim 5, wherein expansion slot is a PCI slot.
